(19) United States
(12) Patent Application Publication
(10) Pub. No.: US 2008/0077539 A1
(43) Pub. Date: Mar. 27, 2008

(54) Markets

(76) Inventor: Tony Drain, Dublin (IE)

Correspondence Address: WALKER & JOCKE, L.P.A., 231 SOUTH BROADWAY STREET, MEDINA, OH, 44256, US

(21) Appl. No.: 11/858,887

(22) Filed: Sep. 20, 2007

Related U.S. Application Data
(60) Provisional application No. 60/826,674, filed on Sep. 22, 2006.

(51) Int. Cl. G06Q 40/00; G06F 17/00

(52) U.S. Cl. 705/36 R; 705/37

(57) ABSTRACT

A method can be provided for investing in a managed list of equities. The method can comprise issuing a security instrument, and using funds invested into said security instrument to purchase equity shares in a group of companies indicated in an investment analysis result. The investment analysis result can be created by analysing information describing a plurality of companies according to a set of analysis rules and selecting a subset of said plurality of companies as said group of companies.

### FIELD

The present invention relates to markets, and in particular but not exclusively to analysing equity markets and using the analysis results to predict future market behaviour.

### BACKGROUND

The securities of thousands of business entities are traded daily on a variety of different stock exchanges and trading markets throughout the world. Securities are traded over such exchanges typically using brokerage houses where individual and corporate investors utilize brokerage agents. In addition a tremendous amount of information is available to investors, which relates to the performance and financial condition on the various companies that have their securities publicly traded. As is well recognized, a universal rule which most investors attempt to follow is the buying of a security at a low price and selling of the security at a higher price or vice-versa when an investor is selling “short”. In doing so, there are normally three basic trading strategies employed by investors of all types. Such strategies include a pure fundamental, bottom-up/top-down analysis, a technical analysis and a combination analysis comprising evaluation tools or models associated with both fundamental and technical approaches to evaluating business entities and the publicly-traded securities associated therewith.

It is thus known for investors to view the past performance of an investment to attempt to judge the future behaviour of that investment. This is known to be a poor indicator of future performance.

The present invention has been made in view of known drawbacks and disadvantages of known systems.

### SUMMARY

Viewed from a first aspect, the present invention provides a system for providing investor access to a managed investment analysis result provided by an investment analysis engine. The system can comprise issuing a security into which funds may be invested and using funds invested into the security to purchase equity shares recommended by the investment analysis result. The system can further comprise providing a return on investments into the security based upon a value alteration of the equity shares. Thereby, the results of a complex investment analysis can be made available to investors in markets other than the market analysed by the analysis and with varying investor credentials.

In one example, the investment analysis engine is configured to analyse performance data for a set of companies in which equity shares are available and to produce as the investment analysis result a subset of the companies for which investment is recommended.

In one example, the investment analysis engine is configured to analyse performance data including selected aspects of quarterly results information for a company.

In one example, the investment analysis engine is configured to include a company in the investment analysis result only if one or more predetermined conditions are satisfied by the company.

In one example, the investment analysis engine is configured to include a company in the investment analysis result only if inclusion of that company in the investment analysis result will cause the investment analysis result as a who to satisfy one or more predetermined conditions.

In one example, the system further comprises selling equity shares in a company which becomes delisted from the subset of companies.

In one example, the system further comprises purchasing equity shares in a company which becomes added to the subset of companies.

Viewed from another aspect, the invention can provide a method for investing in a managed list of equities. The method can comprise issuing a security instrument, and using funds invested into said security instrument to purchase equity shares in a group of companies indicated in an investment analysis result, the investment analysis result being created by analysing information describing a plurality of companies according to a set of analysis rules and selecting a subset of said plurality of companies as said group of companies. Thereby, the results of a complex investment analysis can be made available to investors in markets other than the market analysed by the analysis and with varying investor credentials.

### BRIEF DESCRIPTION OF THE FIGURES

Specific embodiments of the present invention will now be described by way of example only with reference to the accompanying figures in which:

FIG. 1 shows a system schematic of a an investment system.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within and scope of the present invention as defined by the appended claims.

### SPECIFIC DESCRIPTION

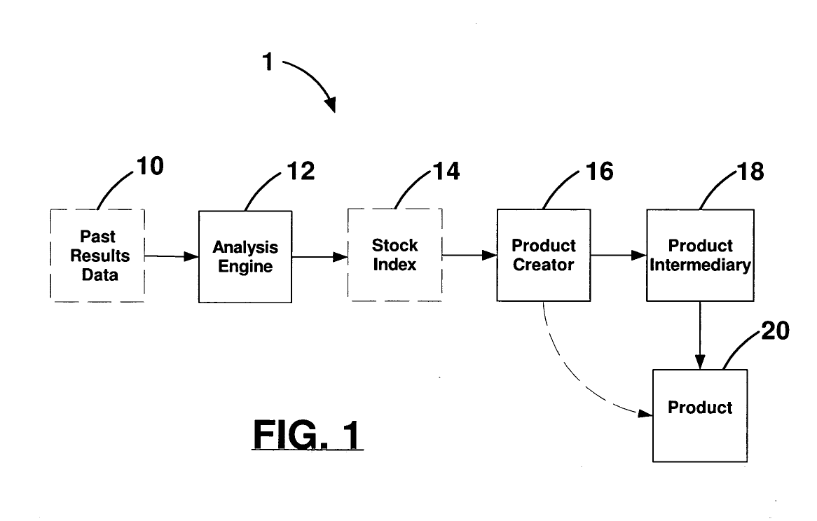

As can be seen from FIG. 1, a system 1 for using analysis results of past behaviour of a tradable investment item in an equity market to predict future market behaviour includes an analysis engine 12 which receives past results data 10 and outputs an analysis result relating to the tradable investment item.

In one example the past results data may include data relating to a large number of investment items. These may include stocks or shares in companies or other equity investments. In one example, the data input to the analysis engine includes past financial and commercial performance data relating to a significant proportion of the major companies of an entire country's economy. In one example, the US economy could be analysed using, for example, data on 5800 companies covering 122 industries over 10 economic sectors can be analysed. In other examples, different selection so companies from any selection of industries in any number of economic sectors in any number of countries could be analysed. The combined analysis results output by the analysis engine 12 for a variety of different tradable investment items may be considered as a stock index 14. The stock index may indicate a selected subset of the available equity investments for which data was input into the analysis engine. In one example, the stock index 12 may comprise a subset of 40 of the available equity investments. The means of choosing the selected subset from the input data can be based on a number of criteria, which are detailed below.

The stock index 14 output by the analysis engine 12 of the present example describes the list of equity investments determined by the engine to represent investments having the best likelihood of investment return outperforming the market average. This may not directly represent the highest likely return, as the likely return may be negative under some market conditions. In such circumstances, the listed investments may represent investments having the smallest likely negative return. It will be appreciated that the listed investments in the stock index might not simply be the group of investments having the highest overall return likelihood as additional constraints may be applied to the index. For example, there may be a requirement for a minimum and/or maximum no of investments relating to companies with a given market capitalisation value band. There may also be restrictions on the percentage of the listed investments which relate to a particular industry or economic sector. In the present example, the analysis engine 12 is configured to recalculate the stock index in response to posting of quarterly results by companies associated with the equities listed in the past results data 10. From a more general example, the analysis engine 12 can update the stock index 14 to reflect updates in the past results data 10.

In one example, the analysis engine 12 uses a number of filters and/or optimisation criteria to create the stock index 14. These may include one or more of the following. Grade Ranking can be used to provide a short term grade for each company based on a full analysis of growth, value, profitability and cash flow. Highest grade companies may be included in the index if they meet the other requirements imposed by the analysis. Rebalancing of the results may be performed each time that the input data is updated. In one example this can be performed in response to the quarterly results filings from the companies analysed. The index can be maintained not to include real estate investment trusts and utility companies. Such trusts/companies tend to perform very differently to other companies (as they typically generate revenue to investors by dividend rather than stock value) so in some examples it may be inappropriate to include them in the index. Indexed companies can have a minimum market capitalisation. In some examples, all companies listed in the stock index must have a market capitalisation greater than $100 million, with at least 25% having a market capitalization greater than $10 billion and no more than 25% having a market capitalisation lower than $1 billion. Economic sector diversification can be applied to avoid overdependence upon any one economic sector. In some examples, no more than 30% of the companies listed in the stock index may reside in any given economic sector, also, a cap of 15% of index companies per sub industry may be applied. In order to provide an unbiased index, use of weightings can be avoided. For example, at the beginning of each rebalancing operation, each company analysed can be allocated an identical dollar value such that each company has an equal ability to affect the index performance. Earning results can also be taken into account. In one example, a company may only be included in the index if it has met its analyst consensus earnings estimate during the earnings report period immediately preceding the index selection during a rebalancing operation.

In some examples, the analysis engine 12 can create a simple action advice indicator for every company equity analysed by the analysis engine 12. This action advice indicator may comprise one entry from a list of possible advices. The list of possible advices may comprise buy, sell and hold entries. In the examples where the stock index 14 comprises a subset of the available entries, the subset may comprise only equity investments with a buy action advice. The subset may comprise a predetermined number of equity investments having a high analysis rating and a buy action advice.

Based on the stock index 14 output by the analysis engine 12, a financial investment product may be generated for offering to investment customers. The content of the product can be generated by a product creator 16. In one example, the product may be an investment fund. In one example, an investor may be able to access the product from the product creator 16 by investing into the fund. In one example, the fund may operate by buying into a debt security such as a note or bond from a financial institution. The debt security can be made available for investment by listing on a stock exchange. In one example, the debt security may be a euro medium term note (EMTN) which is a well-known flexible medium-term debt instrument that is issued and traded outside of Canada and the United States allowing non-North American investor access to the US markets. The note may be managed by human or automated fund managers to attempt to mirror the content of the stock index at any given time. In this example, the EMTN functions as an equity linked note, in that the return on the note is determined by the performance of the equities invested in by the fund. In other examples, other forms of note or even other forms of investment entity could be provided to enable access to the equities in the stock index 14.

The note may be invested in by third party investors in the manner of an account. In some examples, investment in the account may be subject to a minimum investment amount. Also, in some examples, the account may be denominated into fixed price shares. To provide access to the note to investors unable or unwilling to meet the minimum investment amount, or who are prevented by their constitution from investing in investments of this type, an investment fund may also be provided. The investment fund may be open to investment by a wide range of investors and may be subject to different minimum investment limits to the account. The fund is managed to invest funds placed into the fund in the account which provides access to the note. In such an example, the fund may keep a certain minimum percentage of the funds as cash to enable payment of expenses related to the running of the fund.

The note provided by the financial services provider may in fact take the form of a number of notes issued as part of a note programme. Each time that a new investor wishes to buy shares in the note account, the financial services provider may allocate the new investment against existing available shares in the account and/or may commence a new note to expand the number of available shares. By extension, in an example where an investment fund is provided to enable access to the note account, investment in the fund may trigger new purchase of shares by the fund, which may in turn trigger new issue of notes to make available the necessary number of shares in the account.

The note of the present examples is managed by the issuer to invest in equal proportion in the equities listed in the stock index 14. This means that all investments in the note are at any time invested in the subset of available equities identified in the stock index 14. Thus, upon updating of the index by the analysis engine 12, the equity investments held by the note are adjusted to take account of updates to the stock index 14. Thus shares in equities no longer included in the stock index 14 may be sold and shares in equities newly included in the stock index may be purchased. The selling of shares in companies no longer listed in the stock index 14 may be irrespective of the action advice associated with those companies. For example, delisting from the stock index 14 may result in shares being sold, even though the action advice for that company is in fact hold or buy. The note may also be managed to hold a small percentage of the funds invested therein as cash for payment of expenses associated with the running of the note or note programme.

Referring again to FIG. 1, in the present examples, an investor in the note programme, whether directly with the issuer or indirectly through an investment fund, does not have access to the stock index 14 or the mode of operation of the analysis engine 12. The third party investor is able to access the product through the product creator 16 and/or through a product intermediary 18. In the present examples, the product creator 16 may be considered to be the issuer of the note or other security which enables access to the stock index 14 and the product intermediary 18 may be considered to be the provider of an investment fund which enables investment into the note or other security provided by the product creator 16. Whether via the product creator 16 or product intermediary 18, a product 20, which facilitates managed investment in the companies identified in the stock index 14 is made available.

The investor in the product 20 of the present examples, as mentioned above, has no access to the analysis engine 12 or stock index 14. Rather, the investor invests into the product in the knowledge that the stock index 14 will be used as a rulebook for management of the investment without any knowledge of the workings of the analysis or results. The investor will therefore see the results of the investments only in terms of the financial return on the investment.

A more detailed discussion of an example implementation of an analysis engine and resultant stock index as discussed above will now be provided.

The system of the present example is a financial analysis system including the grading of the financial condition and performance of business entities from the growth, value, profitability and cash flow perspectives (also known as bottom-up analysis), as well as the grading of market and economic conditions, industry analysis and market share (also known as top-down analysis) tied to a technical analysis resulting in the determination of one or more grades indicative of one or more strategies associated with the public investing and/or trading of securities of the business entity being evaluated.

Thus, the present example can provide an analysis system for determining the performance and financial condition of a plurality of business entities with the ultimate purpose being to help investors better understand the intricacies of successful investing and thereby empower them to make their own educated decisions. In addition, specific tools can be made available to aid in the investing and trading of securities, including both stocks and bonds, of the various business entities being evaluated. The analysis system of the present example comprises the versatility, adaptability and capacity to evaluate all publicly-traded business entities throughout the world. However, for purposes of clarity and to facilitate a complete and detailed explanation of the subject financial analysis system, the present discussion relates to evaluation of North American business entities including both United States and Canadian companies.

It is further noted that the analysis system of the present example comprises an evaluation of the health of companies that issue stocks and bonds including a technical and fundamental analysis, in order to provide a plurality of investors with truly comprehensive market strategies.

More specifically, the financial analysis system of the present example comprises a plurality of pre-selected analysis components, at least some of which comprise evaluation categories. Further, the various evaluation categories and/or the individual, pre-selected analysis components themselves may include one or more performance indicators representing or defined by various financial and/or performance criteria. As one example, the primary component of the bottom-up analysis system of the present example includes a fundamental analysis component including a plurality of evaluation categories such as growth, value, profitability, and cash flow. In turn, each of the evaluation categories is comprised of various financial and/or performance criteria indicative of the strength, value, potential, and overall status of the individual business entities being evaluated. Simultaneously, a top-down analysis is can be included to alert the user of market and economic conditions, industry conditions and market share dynamics.

A “traffic light,” (through technical analysis) ties the bottom-up (fundamental) analysis of the company with the top-down analysis. In addition, the analysis system of the present example comprises a grading component wherein each of the performance indicators is evaluated by means of a grading range. The various grading ranges are capable of being visually displayed to the investor by means of an alpha-numeric scale or hierarchy which is indicative of the value of each performance indicator. In turn, the grading component of the system of the present example determines a weighted compilation of the values or grades of the individual performance indicators. An additional compilation of the values of the individual performance indicators associated with each analysis component results in the determination of the grade thereof. Final ratings or “final grades” on every company being analyzed are awarded/assigned based on a compilation of all the growth, value, profitability and cash flow indicators/criteria. These final grades are combined with a short-to-medium term technical analysis to produce a buy, hold or sell signal for every company.

The analysis system of the present example further comprises an input data component including at least one, but more practically a plurality of input data sources or “data providers”. As set forth above, the system of the present example is described with specific reference to North American business entities being evaluated. As such, the primary sources of data or data providers, as referred to herein are Thomson Financial and Standard & Poor's Xpressfeed. Therefore, the various references made herein to the data providers, data source or “feeds” will refer to various products provided by the above noted companies. It is further noted that a careful analysis has been made of the variables utilized with each of the above noted data providers. In the case of Xpressfeed, reference will be made to Research Insight and Xpressfeed and the Compustat Data Guide.

The set out above, the system of the present example is directed to a financial analysis system operable to evaluate and more specifically “grade” all publicly-traded companies in the world. As such, the financial analysis system of the present invention is described hereinafter with specific reference to North America business entities which are publicly-traded and active in the United States and Canada.

The financial analysis system of the present example includes a Stock Grader (bottom-up/top-down analysis) component which provides output data appropriate to long term investments, and thus provides the information which can be used as an input to the product creator described above with reference to FIG. 1.

The financial analysis system of the present example can include various analysis components. The various analysis components may include a plurality of evaluation categories, which may in turn comprise a plurality of performance indicators. The various performance indicators, as described in significant detail hereinafter, define or are directly associated with specific financial and/or performance criterion indicative of financial conditions of the securities of a publicly-traded business entity.

The bottom-up/top-down analysis, to be described in detail hereinafter with specific reference to the accompanying Figures is provided to determine and output data in the form of a series of “grades”. The one or more “final grades” are determinative of a business entity's evaluation and a trading evaluation of different categories of publicly-traded securities associated therewith. All analyzed companies will receive a buy, hold or sell rating derived from a combination of the final numerical grade and a short-to-medium-term technical analysis.

The grades are determined in the following manner. Three price moving average (PMA) lines are created for each stock; a one (1) day moving average, a ten (10) day moving average, and a thirty (30) day moving average. The interaction between these three lines will determine the technical part of this signal. If the one-day PMA is above the other two it will be a positive signal. If it is below the ten-day PMA and the thirty-day PMA, it will be considered a negative signal. Overall, the grading works as follows: when a company receives a final fundamental grade above a threshold value and a positive technical signal, it will receive a BUY rating. When a company receives a final fundamental grade above the same threshold and a negative technical signal, it will receive a HOLD rating. When a company receives a final fundamental grade between the same threshold and a lower threshold, regardless of the technical component, it will receive a HOLD rating. When a company receives a final fundamental grade below the lower threshold regardless of the technical outcome, it will receive a SELL rating.

Fundamental Analysis Component

This analysis component, referred to as the bottom-up analysis, includes a plurality of individual performance indicators that can be divided into a plurality of evaluation categories, such as Growth, Value, Profitability and Cash Flow. Input data for these individual performance indicators is gathered from financial statements, earnings releases, financial ratios and market data. All the individual performance indicators are individually graded.

The results from the plurality of individual indicators can each be used as part of a grading component in the form of a final numerical rating or final grade for the entity being evaluated. In practice, a composite of some or all of the performance indicators can be provided with the respective letter grades for each one, as will be explained in greater detail hereinafter. Ratings can be provided for each of the evaluation categories (Growth, Value, Profitability, Cash Flow), and two overall, final, numerical grades can be provided: one for the short-term (less than a year) outlook on the stock, and one for the long-term (more than a year).

Calculation of all of the ratings, grades and grading ranges will be explained hereinafter with specific reference to the grading component and certain ones of the accompanying Figures.

A. Evaluation Category, Growth

Indicator A1. Market Growth (Net Sales vs. Net Income)

This performance indicator is based on a cross-analysis between a company's change in its net income and the change in its net sales. Separate grading ranges can be given for the short-term and the long-term outlook, given that separate variables are useable for each one. A set of variables and example grading letters applicable to the present example are:

Short-Term:
Income Percentage Change—1 year
Sales Percentage Change—1 year

Long-Term:
Income Percentage Change—3 years
Sales Percentage Change—3 years

Grading Range—Short-Term:
A+ Sales percentage increase equal to or greater than 25% and 12 income percentage increase equal to or greater than 10%
A Sales percentage increase between 20 and 25%; income percentage increase between 5% and 10%
A− Sales percentage increase between 15 and 20%; income percentage increase between 3% and 5%
B+ Sales percentage increase between 7 and 15%; income percentage increase between 0 and 3%
B Sales percentage increase regardless of amount; income equal to or greater than previous year
B− Sales equal to or greater than previous year; income percentage decrease between 0.1 and 2%
C Sales percentage decrease between 0.1 and 25%; income percentage decrease between 0.1 and 2%
D Sales percentage decrease between 25 and 50%; income percentage decrease between 2 and 10%
F Sales percentage decrease greater than 50%; income percentage decrease greater than 10%

Grading Range—Long-Term:
A+ Sales percentage increase equal to or greater than 50% and income percentage increase equal to or greater than 40%
A Sales percentage increase between 40 and 50%; income percentage increase between 20% and 40%
A− Sales percentage increase between 30 and 40%; income percentage increase between 15% and 20%
B+ Sales percentage increase between 15 and 30%; income percentage increase between 10% and 15%
B Sales percentage increase between 10 and 15%; income percentage increase between 5% and 10%
B− Sales percentage increase between 5 and 10%; income percentage increase between 1% and 5%
C Sales percentage increase between 0.1 and 5%; income percentage increase between 0 and 1%
D Sales percentage decrease between 0.1 and 5%; income percentage decrease between 0.1 and 2%
F Sales percentage decrease greater than 5%; income percentage decrease greater than 2%

Indicator A2. Relative Price Strength

This indicator is be based upon a chart comparison of the performance of any stock against the S&P 500 Index and the daily trading volume averages of both the stock and the index. The data can include the following two lines:

Line 1: stock's 90-day return

Line 2: S&P 500 Index's 90-day return

The following variables can be used from Standard & Poor's:

Price Daily—Close—6 Month

Trading Volume—Daily

Once the two lines are compared, the interaction between the two, together with volume behavior for the security in question will determine the grades. The volume referred to will be the stock's average daily trading volume for the last three months. Therefore when an increase or decrease in volume is cited, it is with respect to this average. A suitable grade range is the following:
A+ When line 1 breaks line 2 upward, together with a 50% increase in the stock's trading volume for the day at the time the break occurred.
A Line 1 breaks line 2 upward with a 25% increase in volume.
A− Line 1 breaks line 2 upward with a 15% increase in volume.
B+ Line 1 breaks line 2 upward with a 5% increase in volume.
B Line 1 breaks line 2 upward regardless of volume.
B− Line 1 breaks line 2 downward regardless of volume.
C Line 1 breaks line 2 downward with a 10% increase in volume.
D Line 1 breaks line 2 downward with a 20% increase in volume.
F Line 1 breaks line 2 downward with a 30% or higher increase in volume.

The grade for this indicator can be taken into account for the fundamental grading.

Indicator A3. Growth Potential

This performance indicator grades a company's ability to demonstrate solid sales or revenue year-to-year growth. A variable from S&P Compustat can be used:

Sales Percentage Change—1 year

A suitable grading range is the following:
A+ A company will receive this grade when its sales percentage increase over one year is greater than 50%.
A Sales percentage increase (one year) between 40% and 50%
A− Sales percentage increase (one year) between 30% and 40%
B+ Sales percentage increase (one year) between 25% and 30%
B Sales percentage increase (one year) between 20% and 25%
B− Sales percentage increase (one year) between 18% and 20%
C Sales percentage increase (1 year) between 10% and 18%
D Sales percentage increase (1 year) between 0% and 10%
F Sales percentage decrease (1 year), regardless of amount

Indicator A4. Earnings Momentum Indicator

This performance indicator measures the degree of change in a stock's price around the time the company announces earnings. Therefore the system of the present invention will monitor all earnings announcement dates for all stocks. When the date of the last announcement has been determined, historical data can be accessed with the closing prices for the stock from one day prior to the last earnings announcement, to two days after it. The following variables may be used:

Reported Date of Quarterly Earnings per Share

Price—Daily Close

The change in price over this four-day period will determine the grade given to each stock as follows:
A+ This grade will be given to all companies that experience a price increase of 15% or higher over the period described above.
A Those that experience a 10% to 15% increase in price during that time period.
A− 8% to 10% increase in price
B+ 4% to 8% increase in price
B 2% to 4% increase in price
C 0% to 2% decrease in price during the time period described above
D 2% to 10% decrease in price
F Those that experience a price decrease of more than 10%

Indicator A5. Earnings Surprise Indicator:

This indicator measures a company's ability to surprise with their earnings announcements, compared with analysts' consensus estimates. Totaling the percentage change between the announcements and estimates for the last six quarters and then dividing that number by six will produce a historical surprise average. This number will be used to calculate the grades based on the following criteria:
A+ This grade will be awarded to those companies with an average earnings surprise of 30% or higher, above analysts' consensus earnings estimates.
A Average earnings surprise 20% to 30% above analysts' consensus estimates.
A− Average earnings surprise 15% to 20% above analysts' consensus estimates.
B+ Average earnings surprise 10% to 15% above analysts' consensus estimates.
B Average earnings surprise 5% to 10% above analysts' consensus estimates.
B− Average earnings surprise 0% to 5% above analysts' consensus estimates.
C Average earnings surprise 0% to 2% below analysts' consensus estimates.
D Average earnings surprise 2% to 10% below analysts' consensus estimates.
F Average earnings surprise 10% or more below analysts' consensus estimates.

B. Evaluation Category-Value

Indicator B1. Capital Structure

Capital structure is calculated by dividing total debt by the sum of total debt and share holders equity: the variables utilized are:

Debt total-quarterly

Stockholders' equity total-quarterly

A suitable grading range is:
A+ All companies with Total Debt equal to or below 0%
A Total debt equal to or below 15%
A− Total debt equal to or below 25%
B+ Total debt equal to or below 30%
B Total debt equal to or below 35%
B− Total debt equal to or below 40%
C Total debt equal to or below 45%
D Total debt equal to or below 50%
F Total debt above 50%

Indicator B2. P/E Analysis

The following formula will be used to compute a company's optimum price to earnings ratio based on historical earnings:

Optimum PE=(37.5+8.8 g)/i

Where:

g=growth rate². This rate can be calculated based on the predicted values of earnings per share, computed from a regression analysis calculation; the regression analysis can use quarterly EPS numbers for the last twelve quarters, using the following variable:

Earnings per share basic excluding extraordinary items.

Once g is obtained, the optimum P/E can be calculated based on the formula shown above, where (i), or the risk free rate of interest, will be the yield of the 10 year government note:

Government Notes—10 Year.

Finally, the optimum P/E is compared to the published P/E and the grades are derived based on the criteria of the analysis system of the present example. The following variable is used to obtain the published P/E:

Price to Earnings ratio—Current

The following formula can be used to determine the relationship between the two ratios:

1—(PE/Optimum PE),

A suitable grading range is the following:
A+ This grade will be awarded to all stocks that have an actual PE ratio at least 30% smaller than the optimum PE resulting from the formula. For example, if a stock has a PE ratio of 20 according to the formula, its actual PE must be 14 (30% discount) or lower in order to qualify for an A+.
A PE ratio 20% to 29.9% lower than optimum PE
A− PE ratio 10% to 19.9% lower than optimum PE
B+ PE ratio 0.1% to 9.9% lower than optimum PE
B PE ratio 0.1% to 15% higher than optimum PE
B− PE ratio 15.1% to 25% higher than optimum PE
C PE ratio 25.1% to 50% higher than optimum PE
D PE ratio 50.1% to 100% higher than optimum PE
F PE ratio more than 100% higher than optimum PE

Indicator B3. Price to Book Ratio

The following formula can be used:

{Price close(daily)*common shares outstanding(quarterly)}/{Total Common Equity(Quarterly)}

The following grading range can be used:
A+ This grade will be awarded to all companies with a Price to Book ratio between 0 and 3.
A P/B between 3.1 and 6
A− P/B between 6.1 and 9
B+ P/B between 9.1 and 12
B P/B between 12.1 and 15
B− P/B between 15.1 and 18
C P/B between 18.1 and 21
D P/B between 21.1 and 24
F P/B above 24.1 or below 0

Indicator B4. Price to Cash Flow Ratio

This indicator can be based on the following formula:

Current Price/(Cash Flow/Common Shares Outstanding)

The following variables can be used:

Price—Current

Cash Flow

Common Shares Outstanding—Quarterly

The following grading range can be used:
A+ This grade will be awarded to all those companies that have a Price to Cash Flow Ratio between 0 and 5
A P/CF between 5.1 and 10
A− P/CF between 10.1 and 15
B+ P/CF between 15.1 and 20
B P/CF between 20.1 and 25
B− P/CF between 25.1 and 30
C P/CF between 30.1 and 35
D P/CF between 35.1 and 40
F P/CF above 40 or below 0

Indicator B5. Price to Sales Ratio

Every company's price to sales ratio will be compared against the industry average to determine the grade. Therefore, the industry average will be calculated by adding all the P/S ratios in the same industry and dividing the sum by the total number of companies in the sub-industry that report an actual P/S figure. The following variable can be used:

Price to Sales per Share

The following grading range can be used:
A+ This grade will be awarded to all companies with a price to Sales ratio that is 20%+lower than the industry average
A P/S 15% to 20% below the average
A− P/S 10% to 15% below the average
B+ P/S 5% to 10% below the average
B P/S 0% to 5% below the average
B− P/S 0% to 5% above the average
C P/S 5% to 10% above the average
D P/S 10% to 15% above the average
F P/S 15%+above the average

Indicator B6. Market Value

This component can be based on the following calculation:

Market Capitalization/(NetIncome+Depreciation and Amortization+Provision for Loan or Asset Losses−Extraordinary Items)

The result of the calculation will be referred to as the MV coefficient. However, of all the variables presented in this equation, only two will always be available from Standard & Poor's Compustat North American Database; they are Market Capitalization and Net Income. All others are only reported in some cases and not in others. When they are not reported, the grading process can be carried out by simply be ignoring the missing data. The following reasons explain the availability of those variables:

Depreciation and Amortization: generally this variable will be available, but there are a number of companies that do not report it.

Provision for Loan or Asset Losses: this is a variable that is only reported by certain Financial Institutions. It is generally reported only by Banks.

Extraordinary Items: many companies do not always report this item.

The following variables can be used:

Market Value (MV) Daily

Net Income Quarterly

Depreciation and Amortization Quarterly

Provision for Loan/Asset Losses Quarterly

Extraordinary Items Quarterly

The following grade range can be used:
A+ This grade will be awarded to all companies with an MV coefficient equal to or lower than 10.
A MV between 10.1 and 15
A− MV between 10.1 and 20
B+ MV between 20.1 and 25
B MV between 25.1 and 30
B− MV between 30.1 and 35
C MV between 35.1 and 40
D MV between 40.1 and 45
F MV above 45

C. Evaluation Category—Profitability

Indicator C1. Asset Utilization

This indicator is applicable to all companies except the likes of Banks, Insurance Companies, and REIT's (Real Estate Investment Trusts). Discrimination among industries can be based on the Global Industrial Classification System (GICS) developed by Standard & Poor's available in the Compustat Database. GICS is a classification of economic sectors, industry groups, industries and sub-industries. There are a total of 10 economic sectors, 23 industry groups, 59 industries, and 122 sub-industries, extant in the classification to date.

The Asset Utilization Indicator will typically be used to grade all companies in all GICS economic sectors except for industry Group 4010 (Banks), Industry Group 4030 (Insurance), and a sub-industry 40401010 (Real Estate Investment Trusts). Two separate grading ranges will be used, one for Industry Group 4020 (Diversified Financials) and another one for all other companies. The variables used for Asset Utilization Indicator can be:

Net Income

Assets—Total

The following formula can then be used to determine the Asset Utilization coefficient:

(Net Income/Total Assets)×100

A suitable Grading Range for GICS 4020 (Diversified Financials) is:
A+ This grade will be awarded to all companies that have an Asset
Utilization coefficient above 2.75%
A Asset Utilization above 2.25%
A− Asset Utilization above 1.75%
B+ Asset Utilization above 1.25%
B Asset Utilization above 0.75%
B− Asset Utilization above 0.50%
C Asset Utilization above 0.25%
D Asset Utilization above 0%
F Negative Asset Utilization coefficient.

A suitable Grading Range for all companies except GICS 4010, 4020, 4030, 404010101 is:
A+ This grade will be awarded to all companies that have an Asset Utilization coefficient above 20%
A Asset Utilization above 15%
A− Asset Utilization above 12%
B+ Asset Utilization above 10%
B Asset Utilization above 8%
B− Asset Utilization above 5%
C Asset Utilization above 2%
D Asset Utilization above 0%
F Negative Asset Utilization coefficient.

Indicator C2. Net Interest Margin

This indicator can substitute the Asset Utilization Indicator for all those companies belonging to Industry Group 4010 (banks). The following variable from S&P is used:

Net Interest Margin—Quarterly

The following grading range can be used:
A+ This grade will be awarded to all companies that have a Net Interest Margin of 5.5% or higher.
A Net Interest Margin between 5% and 5.4%
A− Net Interest Margin between 4.5% and 4.9%
B+ Net Interest Margin between 4.0% and 4.4%
B Net Interest Margin between 3.5% and 3.9%
B− Net Interest Margin between 3.0% and 3.4%
C Net Interest Margin between 2.5% and 2.9%
D Net Interest Margin between 2.0% and 2.4%
F Net Interest Margin of 2% or lower

Indicator C3. Value of Premiums

This indicator can substitute the Asset Utilization Indicator for all of those companies belonging to Industry Group Code 4030 (insurance).

The indicator can be based on the following formula:

(Operating Income/Net Sales)×100

The result can be termed: “Value of Premiums”.

The following variables can will be used:

Operating Income Before Depreciation—Quarterly

Net Sales—Quarterly

The following grading range can be used:
A+ This grade will be awarded to all companies that have a Value of Premiums equal to or greater than 40%
A Value of Premiums between 35% and 39.9%
A− Value of Premiums between 30% and 34.9%
B+ Value of Premiums between 25% and 29.9%
B Value of Premiums between 20% and 24.9%
B− Value of Premiums between 15% and 19.9%
C Value of Premiums between 10% and 14.9%
D Value of Premiums between 7% and 9.9%
F Value of Premiums below 7%

Indicator C4. Yield Analysis

This indicator can substitute the Asset Utilization Indicator for all companies belonging to sub-industry codes 40401010 (Real Estate Investment Trusts) and 55 (utilities) It can be based on the following formula:

Dividend Yield+Return on Equity

The following variables can be used:

Dividend Yield

Return on Equity

The following grading range can be used:
A+ This grade will be awarded to all companies that have a Dividend Yield+Return on Equity equal to or greater than 30.
A Dividend Yield+Return on Equity between 27 and 29.9
A− Dividend Yield+Return on Equity between 24 and 26.9
B+ Dividend Yield+Return on Equity between 21 and 23.9
B Dividend Yield+Return on Equity between 18 and 20.9
B− Dividend Yield+Return on Equity between 15 and 17.9
C Dividend Yield+Return on Equity between 12 and 14.9
D Dividend Yield+Return on Equity between 9 and 11.9
F Dividend Yield+Return on Equity lower than 9

Indicator C5. Capital Utilization (Quality of Management)

This performance indicator is a cross examination of a company's long-term debt as a percentage of its common equity with its return on equity. The following formula can be used for the quality management component of the indicator:

[Long Term Debt/(Long Term Debt+Stockholders' Equity)]×100

The result of this equation will be referred to as the Quality of Management coefficient (QMC).

The following variables can be used:

Long Term Debt—Quarterly

Stockholders' Equity—Total—Quarterly

Return on Equity—Quarterly

The following grading range can be used:
A+ Company must have a Quality of Management Coefficient (QMC) above 30%, and Return on Equity (ROE) above 30%
A QMC above 30% and ROE above 28%
A− QMC above 30% and ROE above 25%
B+ QMC above 0% and ROE above 23%
B QMC above 0% and ROE above 20%
B− QMC above 0% and ROE above 18%
C QMC above 0% and ROE above 15%; or QMC above 100% and ROE above 18%
D QMC above 0% and ROE above 10%; or QMC above 100% and ROE above 12%
F QMC above—infinity and ROE above—infinity

Indicator C6. Net Margins

This performance indicator measures a company's Net Income with respect with its Net Sales. The following formula can be used:

[(Net Income+Depreciation and Amortization+Provision for Loan or Asset Losses−Extraordinary Items)/Net Sales]×100

The result of this formula will be referred to as the Net Margin coefficient.

The following variables can be used:

Net Income Quarterly (Loss)

Depreciation and Amortization Quarterly

Provision for Loan/Asset Losses Quarterly

Extraordinary Items Quarterly

Sales (Net) Quarterly

However, of all the variables presented in this equation, normally only two will be available from Standard & Poor's Compustat North American Database; they are Net Sales and Net Income. The others are typically reported in some cases but not in others. When they are not reported, it will not affect the grading process, as their absence can simply be ignored.

The following grading range can be used:
A+ This grade will be awarded to all companies with a Net Margin coefficient (NM) of 50% or higher.
A NM between 30% and 49.9%
A− NM between 20% and 29.9%
B+ NM between 15% and 19.9%
B NM between 10% and 14.9%
B− NM between 7% and 9.9%
C NM between 5% and 6.9%
D NM between 3% and 4.9%
F NM of 2.9% or below

Indicator C7. Relative Margins

This performance indicator measures a company's Net Profit Margin (NPM) as it relates to its peers. Therefore, using the Global Industry Classification System codes presented in Compustat the average Net Profit Margin can be calculated for each sub-industry (eight digit GICS code). For example, GICS Code 40101010 (Banks) presently comprises a total of 671 companies. To calculate the average NPM for the sub-industry, the NPM for every company must be added and divided by 671, the number of observations in the group. This is the figure against which the NPM of all companies in the group will be measured. The same is done for all other GICS sub-industries.

The following variable can be used:

Net Profit Margin (as calculated in the Net Margins indicator)

The following grading range can be used:
A+ This grade will be awarded to all companies that have a Net Profit Margin at least 25% higher than the sub-industry's average Net Profit Margin.
A NPM 15% to 24.9% higher than sub-industry's NPM
A− NPM 5% to 14.9% higher than sub-industry's NPM
B+ NPM 0.1% to 4.9% higher than sub-industry's NPM
B NPM equal to the sub-industry's NPM
B− NPM 0.1% to 0.49% lower than sub-industry's NPM
C NPM 0.5% to 14.9% lower than sub-industry's NPM
D NPM 15% to 24.9% lower than sub-industry's NPM
F NPM at least 25% lower than sub-industry's NPM

Indicator C8. Return on Equity

This performance indicator measures a stock's return on equity by itself. The following variable can be used:

Return on Equity (ROE)—Quarterly

The following grading range can be used for all companies except those that belong to Industry group 4030 and Industry 401010.
A+ This grade will be awarded to all companies that have a ROE of 40% or higher.
A ROE between 30 and 39.9
A− ROE between 26 and 29.9
B+ ROE between 23 and 25.9
B ROE between 20 and 22.9
B− ROE between 18 and 19.9
C ROE between 15 and 17.9
D ROE between 5 and 14.9
F ROE below 5

For companies that belong to Industry Group 4030 and Industry 401010, the following range can be used:
A+ROE above 20%
A ROE between 15% and 20%
A− ROE between 12.5% and 15%
B+ ROE between 10% and 12.5%
B ROE between 8% and 10%
B− ROE between 7% and 8%
C ROE between 6% and 7%
D ROE between 5% and 6%
F ROE below 5%

Indicator C9. Quality of Revenues

This performance indicator is derived from a cross analysis of a stock's Price to Earnings Ratio and its Return on Equity. The following formula can be used:

ROE/PE

The resulting number will be referred to as the Quality of Revenues coefficient.

The following variables can be used:

Return on Equity—Quarterly

Price to Earnings Ratio Daily

The following grading range can be used:
A+ This grade will be awarded to all companies with a Quality of Revenues coefficient (QR) equal to or greater than 2.
A QR between 1.75 and 1.99
A− QR between 1.5 and 1.74
B+ QR between 1.4 and 1.49
B QR between 1.3 and 1.39
B− QR between 1.0 and 1.29
C QR between 0.5 and 0.9
D QR between 0.1 and 0.49
F QR below 0.09
D Evaluation Category—Cash Flow

Indicator D1. Cash Flow Growth

This indicator will measure the year-to-year growth of a company's Cash Flow. It therefore compares the company's cash flow in the most recent quarter, to the company's cash flow in the same quarter a year ago.

The following indicator is used:

Cash Flow—Quarterly

The following grading range can be used:
A+ This grade will be awarded to all companies that show a year-to-year Cash Flow growth of 40% or more.
A Cash Flow growth between 35% and 39%.
A− Cash Flow growth between 30% and 34%.
B+ Cash Flow growth between 25% and 29%.
B Cash Flow growth between 20% and 24%.
B− Cash Flow growth between 15% and 19%.
C Cash Flow growth between 5% and 14%.
D Cash Flow growth between 0% and 5%.
F Negative Cash Flow growth.

Indicator D2. EBITDA Margin

EBITDA margin performance indicator is the ratio of Earnings Before Interest and Taxes and Depreciation and Amortization to Net Sales. In the case of this performance indicator, annual figures will be used. The following variable is used:

EBITDA Margin—Annual

The following grading range can be used to determine the grades:
A+ This grade will be given to all companies with an EBITDA Margin of 50% or higher.
A EBITDA Margin between 45% and 49%.
A− EBITDA Margin between 40% and 44%.
B+ EBITDA Margin between 30% and 39%.
B EBITDA Margin between 20% and 29%.
B− EBITDA Margin between 10% and 19%.
C EBITDA Margin between 5% and 9%.
D EBITDA Margin between 0% and 4%.
F Negative EBITDA Margin.

Indicator D3. Debt to Cash Flow

This indicator is based on the following ratio:

Total Debt/Cash Flow

The Following variables from Compustat can be used:

Debt (Long-Term)—Total, Quarterly

Cash Flow—Quarterly

The following range can be used to determine the grades:
A+All companies with a ratio smaller than 2
A Ratio 2-5
A− Ratio 5-8
B+ Ratio 8-10
B Ratio 10-15
B− Ratio 15-20
C Ratio 20-25
D Ratio 25-30
F Ratio above 30, and all negative values

Indicator D4. Interest Coverage Ratio

The following formula is used:

(Income before extraordinary items, quarterly+interest expense, quarterly)/(interest expense, quarterly)

The following range can be used to determine the grades:
A+ Interest Coverage Ratio above 20
A ICR 15-20
A− ICR 10-15
B+ ICR 8-10
B ICR 5-8
B− ICR 3-5
C ICR 1.5-3
D ICR 0-1.5
F ICR below 0

Indicator D5. Economic Value Added

The following variables from Compustat can be used:

Return on Investment—Annual

S&P Domestic Long-Term Issuer Credit Rating—Current

Tax Rate—Annual

Long-Term Debt as a Percentage of Total Capital—Annual

Beta—Monthly

Government Notes—10 Year

The following table can be used to determine the company's interest rate (that it pays for debt financing) based on its Domestic Long-Term Issuer Credit Rating:

SPDRC Code Interest Rate

1-5 5.0%

6-9 6.0%

10-13 7.0%

14-18 8.0%

19-20 10.0%

21-23 11.0%

N/A 7.5%

In the case of all companies that do not have an S&P rating (SPDRC), by default they can be automatically given a 7.5% interest rate.

The following calculations produce the EVA indicator:

After Tax Interest Expense=1−TR

Weighted Average After Tax Cost of Debt=Interest Rate obtained from SPDRC table)×After Tax Interest Expense×LTDCAP; all numbers must be calculated as decimal values since they are percentages.

Market Risk Premium=Market Risk Premium×BETA

Total Cost of Equity=NOTE10YR+Risk Adjusted Premium

Percentage of Capital that is Equity=1−LTDCAP

Weighted Average After Tax Cost of Equity=Total Cost of Equity×Percentage of Capital that is Equity

Total Weighted After Tax Cost of Capital=Weighted Average After Tax Cost of Debt+Weighted Average After Tax Cost of Equity

Economic Value Added(EVA)=ROI−Total Weighted After Tax

Cost of Capital

Grading range for all companies EXCEPT GICS 4010, 4020, 4030, 40401010;

All companies with a negative ROI will automatically receive an F for this indicator.
A+ All companies with EVA above 15%
A All companies with EVA above 10%
A− All companies with EVA above 8%
B+ All companies with EVA above 6%
B All companies with EVA above 5%
B− All companies with EVA above 3%
C All companies with EVA above 1%
D All companies with EVA above 0%
F All companies with a negative EVA

Grading Range for all companies in GICS 4010, 4020, 4030, 40401010:

All companies with a negative ROI will automatically receive an F for this indicator.
A+ All companies with EVA above 5%
A All companies with EVA above 4%
A− All companies with EVA above 3%
B+ All companies with EVA above 2%
B All companies with EVA above 1%
B− All companies with EVA above 0.5%
C All companies with EVA above 0.24%
D All companies with EVA above 0%
F All companies with a negative EVA

Indicator D6. Retention Rate

This indicator can be based on the following variable from Compustat:

Reinvestment Rate—Quarterly

The following range can be used to determine the grades:
A+ All companies with a quarterly reinvestment rate above 30%
A Above 25%
A− Above 20%
B+ Above 15%
B Above 10%
B− Above 5%
C Above 2%
D Above 0%
F Below 0%

E Evaluation Category—Bonus Points

The following two performance indicators reward stocks that satisfy certain parameters. Those that meet the requirements can be awarded specific upgrades in certain of the evaluation categories of the Fundamental Analysis Component set forth above.

Indicator E1. Market Leaders

In order for a company to qualify as a Market Leader a number of conditions must be satisfied. A set of suitable examples is: it must be a non-utility stock; it must have a market capitalization greater than the average for all stocks; it must have a number of shares outstanding greater than the average number for all stocks; it must have an annual Cash Flow figure greater than the average for all stocks; finally it must have annual sales 50% greater than the average for all stocks. Therefore, averages for all the described categories can be calculated for all stocks within the analyzed region (e.g. North America). GICS Economic Sector 55 (Utilities) can be excluded from this calculation.

The following variables can be used:

Market Value Daily

Common Shares Outstanding

Cash Flow

Sales (Net)

All stocks that meet the standards here presented will receive an upgrade in all categories of the Fundamental Analysis Component. For example, if a stock received a B− in any indicator, it will be upgraded to B. The same will occur with all indicators.

Indicator E2. Market Share Increases

Finally, this last bonus point performance indicator compares companies against their peers with relation to Net Sales. Therefore a Market Share figure is calculated for every company within the GICS sub-industry. To calculate the total market figure for every sub-industry, the Net Sales of all companies in the group are added. To determine a company's Market Share, the following formula can then be used:

(Net Sales/Sum of Net Sales for sub-industry)×100

The following variable is thus used:

Sales (Net)

The bonus points for the Market Share category will be awarded as follows. When a company has a market share increase in a year greater than 5% with respect to its annual sales three years ago, it will receive an upgrade in all indicators of the Profitability and Growth groups.

Stock Grading System

Based on the resulting grading ranges for each of the performance indicators of the various evaluation categories (Growth, Value, Profitability, Cash Flow) of the Fundamental Analysis Component, a final numerical grade will be assigned to every stock, based on investors' preference classifications.

The grade is placed within a range between zero and one hundred. A given numerical points level can be awarded for every letter grade given out by every performance indicator. The four evaluation categories can be weighted as explained below. For the purposes of the present example, two grades are explained in detail, one for the short-term and one for the long-term.

For the long term result, Growth makes up 14% of the overall result, Value 40%; Profitability 25%; and Cash Flow 21%.

For the short term result, Growth makes up 41% of the overall result; Value 14%; Profitability 24%; and Cash Flow 21%.

GICS industry 40401010 (Real Estate Investment Trusts) and GICS economic sector 55 (Utilities) only receive one overall final grade: in this category Growth makes up 0% of the overall result; Value 10%; Profitability 60%; and Cash Flow 30% as shown in FIG. 2C. These two groups are graded differently from all other companies. The Growth and Value groups remain the same (even though the growth group is not accounted for when calculating the final grade. The profitability group will be as follows:

1. Yield Analysis (×3)

2. Net Margins (×1.5)

3. Return on Equity (×1.5)

The Cash Flow group will be as follows:

1. EBITDA Margin (×4)

2. Debt/Cash Flow Ratio (×2)

Customization and Variation

The system as described herein can be tailored to suit a particular investment approach and style. Thus, the various indicators set out above can be altered to adjust the calculation formulae and/or the grading ranges. Also, certain indicators may be omitted or additional indicators included. Furthermore, the weightings of the different indicators within each evaluation category can be adjusted, as can the relative weights of the categories to make up the final result.

In the present example, a default is set of all companies being graded using the criteria explained above and in the short and long-term tables, which assigns the overall final grades based on a balanced view of the four main categories of the fundamental analysis. Deviations from this default can be set per product or per product group in terms of how the analysis system result is applied to the product generator described above with reference to FIG. 1.

Buy, Hold, and Sell Results

As discussed above, each analyzed stock or security can be assigned a final Buy, Hold or Sell result based on the results of the various analysis stages. The Buy, Hold or Sell rating can be derived from a combination of the final numerical grade and a short to medium term technical analysis.

As mentioned above, three price moving average lines are drawn for each stock; a one day moving average(1-PMA), a ten day moving average (10-PMA), and a thirty day moving average (30-PMA). The interaction between theses three lines can be used to determine the technical part of the overall result. If the 1-day PMA is above the other two, it will be a positive signal. If it is below the 10-day and 30-day PMA's, it will be considered a negative signal. The particular allocation of a final result compares the numerical grade discussed above to a pair of thresholds.

BUY When a company receives a final numerical grade above an upper threshold and a positive technical signal, it will receive a buy rating.

HOLD When a company receives a final numerical grade above the upper threshold and a negative technical signal, it will receive a hold rating; and when the company has a final numerical grade between the upper threshold and a lower threshold regardless of the technicals it will receive a hold rating.

SELL When a company receives a final grade below the lower threshold, regardless of the technical outlook, it will receive a sell rating.

In the present example, the upper threshold can be set as 65, and the lower threshold can be set as 55. Other thresholds may be appropriate to alternative markets and alternative weightings of individual indicators within the result.

In the present example, where an immediate BUY, SELL or HOLD result is needed to cause a portfolio to track an optimal path in terms of investment value, the BUY, SELL or HOLD result is based upon a short-term final numerical value. Other final numerical values based upon different weightings can be used if desired or required.

The stock index discussed above with reference to FIG. 1 can comprise available stocks, with a rating for each, or can include a selection of stocks from the total pool of available stocks. Each stock within the stock index can be assigned the BUY SELL OR HOLD rating discussed above. Where the stock index includes less than all available stocks, the selection of which stocks to include in the index can be influenced by the absolute numerical rating of the stock, a rating value of the stock based on different weightings, and/or a previous inclusion of the stock in the stock index. Additionally, certain other factors can be taken into account when determining which stocks to include in the stock index. Examples of such other factors are described below.

Firstly, a top-down analysis can be provided to indicate overall market conditions. These can affect different market segments, industries and subindustries differently, so they can be used to influence the selection of stocks for inclusion in the stock index. Three possible components of such an analysis are explained below:

Economy and Market Conditions. This group of indicators aims to keep track of the economy and the financial markets of the geographical region with which a business entity is primarily associated. As set forth above, the system of the present inventions is applicable for use in evaluating publicly-traded entities throughout the world. However, for purposes of clarity, the indicators discussed hereinafter are applicable to the United States economy and its financial markets. Like the performance indicators of the Fundamental Analysis Component, a grading system has been devised to quantify the indicators here included. They have been divided into two groups: Monetary indicators, and Momentum indicators. In some arrangements, five possible outcome results are applied using a combination of the indicators.

Monetary Indicators. These three indicators measure monetary policy decisions enacted by the Federal Reserve (or equivalent national financial regulator/central bank). They make up the economic portion of this top-down analysis.

The first monetary indicator is the Prime Rate Indicator which measures changes in the prime rate, the rate charged by banks to its preferred (i.e. low risk) customers. In one implementation, anything above 8% is considered a high interest rate. Anything below this value is considered low. A buy signal is generated by any initial cut in the prime rate if the prime's peak was less than 8%, or by the second of two cuts or a full 1% cut starting from a prime rate of 8% or higher. A sell signal is generated by any initial hike in the prime rate if the prime's low is 8% or greater or by the second of two hikes or on a full 1% jump if the prime rate's low is less than 8% or greater. To fit this indicator into the pattern of monetary indicators, a BUY signal will be awarded two points, and a SELL signal will be awarded zero points.

The second monetary indicator is the Federal Reserve Indicator. As is widely known, the Federal Reserve (or equivalent national financial regulator/central bank) has the task of regulating the economy's money supply. This provokes a high sensitivity on the market's part to react to any policy changes made by the Fed. Therefore it is useful to include a check against this for accuracy's sake in the analysis model. Traditionally the Fed has had three main tools to implement monetary policy: reserve requirements, interest rates, and open market operations. The first two will be examined and a system will be explained to keep track of them. Reserve requirement changes and interest rate changes are treated separately, in order to be able to keep score. However, the points system works the same for both. In the case of interest rates the Federal Funds Rate is observed in the present implementation, and all others are disregarded. Negative Points are awarded when an increase occurs in either the federal funds rate or reserve requirements. A hike in either one receives minus one (−1) point for that component of the Fed Indicator. It would also wipe out any positive points that might have been there at the time. The negative point remains for six months, after which it becomes stale and is discarded. Positive Points are awarded when a decrease occurs in either the federal funds rate or reserve requirements. Moves by the Federal Reserve towards easing monetary policy have a greater positive impact on stock prices than the negative effect created by tightening moves. So, an initial cut in either of the two tools not only wipes out any negative points that may have accumulated, but it also kicks in two (2) positive points. An initial cut is the first one following a rise in that component of the indicator. Or a cut is “initial” if it marks the first change in that tool in at least two years. As an initial change grows stale, one of the two points is lost six months later and the remaining point falls out a year later. If a second reduction were made in the federal funds rate, it would add one more point, for a total of three points. That point, resulting from the second cut, would become stale six months later and would be dropped. More consecutive cuts in the rate would be treated the same way. In order to calculate the Federal Reserve indicator, the sum of points from the federal funds rate and the reserved requirement scores is calculated. If the systems discussed above are implemented, the scores will not go any lower than −4, or any higher than +7.

The third monetary indicator is the Installment Debt Indicator. This measures the public's demand for loans in the economy, which has an important effect on interest rates. When demand for loans rises excessively, it puts upward pressure on interest rates. When it falls it works to lower interest rates. This model will focus on consumer installment debt. The figures on such debt are reported monthly with a delay of about six weeks. The figures are reported both on a seasonally adjusted basis and a non-seasonally adjusted basis. We will use the latter. However, the only figure we will need is the year-to-year percentage change in installment debt. Expansions of the installment debt figure will be treated as bearish, and contractions as bullish. The borderline level will be a 9% change. A positive signal will be produced when the year-to-year change in installment debt has been falling and drops to under 9%. This will translate into two (2) points. A negative signal will be produced when the year-to-year change has been rising and reaches 9% or higher. This, in turn, will translate into zero (0) points.

Momentum Indicators. Unlike the monetary indicators, the following three only deal with price and volume data from the stock market.

The first momentum indicator is the Advance\Decline Indicator which keeps track of all the stocks that advance on a given day, versus the ones that decline. The model will ignore stocks that remain unchanged after a day of trading. In the present implementation data from the New York Stock Exchange is used since this is widely considered to be a good measure of the market's performance. Data from different or additional exchanges can be used. To calculate the Advance\Decline ratio, the number of stocks that finished the day up is divided by the number of stocks that finished the day down. Then the ratio is tracked over a ten-day period. When advances lead declines by a ratio of 2-to-1 over a period of ten days, the model will give a positive signal which translates into 1 point.

The second momentum indicator is the Up Volume Indicator which uses the ratio of up volume to down volume. Up volume comprises the total volume of all stocks that rise on a given day, and down volume totals all those that decline. Again, the stocks that remain unchanged are ignored. An assumption can be made that when 90% or more of the volume (ignoring unchanged volume) is on the upside in a given day, it is a significant sign of positive momentum. In other words, when daily up-volume leads down-volume by a ratio of 9-to-1 or more, this is an important signal of momentum. On any given day when this happens, the system will produce a positive signal which translates into 1 point.

The third momentum indicator is the Four Percent Model which tracks the weekly close of the Standard and Poor's 500 Index for the creation of this model. This trend-following model gives a positive signal when the weekly Index rallies 4% or more from any weekly close. It then gives a negative signal when the weekly close of the S&P 500 drops by 4% or more from any weekly peak. (Note: this means 4% of change, not four points.) A positive signal translates into 2 points, and a negative signal translates into 0 points

The points awarded by the system to each indicator must are taken into account to provide a grading system for the monetary and momentum indicators as a whole. The maximum possible score from all the monetary and momentum indicators is twelve points. In the present implementation, the point system is divided into five ranges, which will in turn determine five different result values to be used in determining the overall output result:

9-12 points Very Favorable Market Conditions

7-8 points Favorable Market Conditions

5-6 points Neutral Market Conditions

4 points Unfavorable Market Conditions

0-3 points Very Unfavorable Market Conditions.

Further additional factors which can be taken into account include: growth in Gross Domestic Product in the geographic region of the stock, Consumer Price Index Graph in the geographic region of the stock, and Unemployment Rate in the geographic region of the stock.

Furthermore, and industry analysis may be taken into account when choosing stocks for the stock index. From time to time particular industries or sectors fall out of favor with the market. Therefore it can be useful to keep track of how all industry sectors perform in terms of returns. The rankings can be based on average market returns per industry for different periods such as one, three and six months, year-to-date, 52-weeks, and three-years.

Also, a market share analysis may be influential in choosing stocks for the stock index. All companies within an industry can be ranked based on their market share. Historical market share data can also be taken into account.

Also, as noted above, the selection of stocks for inclusion in the stock index may include certain restrictions on the types and fundamental nature of the companies than can be included in the index. In one example, a set of rules to be satisfied by the stock index as a whole may be: all stocks must have a market capitalization above $100 million, at least 10 stocks must have a market capitalization above $10 billion, no more than 10 stocks may have a market capitalization below $1 billion, all stocks must have at least a three month average daily traded value of $2 million, no more than 30% of the selections may belong to the same economic sector, no more than 15% of the selections may belong to the same sub-industry, all selections must have met their most recent earnings consensus estimate, and no real estate investment trusts or utilities are selected to the index. Other rules sets may be applied dependant upon the requirements of users of the index, and thus by extension customers of the product created at the product creator.

Thus there have now been described a number of examples of considerations which can be applied to the selection of stock for inclusion in the stock index, as well as a product creation system which includes using results generated by the analysis system being used to generate products.

As will be apparent from the foregoing description, one or more steps of the methods used to implement the invention may be carried out using one or more computer systems. For example the analysis of the past results data for the analysed companies may be performed using a computer system. Also, the management of the investment product to track the companies indicated in the stock index may be performed by a computer programmed to make trading operations according to the list of companies/equities in the stock index. Also, access to the investment product for an investor may be implemented using a computer system, and such a computer system may be used whether the access to the investment product is via a product provider or a product intermediary.

1. A system for providing investor access to a managed investment analysis result provided by an investment analysis engine, the system comprising:
issuing a security into which funds may be invested;
using funds invested into the security to purchase equity shares recommended by the investment analysis result;
providing a return on investments into the security based upon a value alteration of the equity shares.

2. The system of claim 1, wherein the investment analysis engine is configured to analyse performance data for a set of companies in which equity shares are available and to produce as the investment analysis result a subset of the companies for which investment is recommended.

3. The system of claim 2, wherein the investment analysis engine is configured to analyse performance data including selected aspects of quarterly results information for a company.

4. The system of claim 2, wherein the investment analysis engine is configured to include a company in the investment analysis result only if one or more predetermined conditions are satisfied by the company.

5. The system of claim 2, wherein the investment analysis engine is configured to include a company in the investment analysis result only if inclusion of that company in the investment analysis result will cause the investment analysis result as a who to satisfy one or more predetermined conditions.

6. The system of claim 2, further comprising selling equity shares in a company which becomes delisted from the subset of companies.

7. The system of claim 2, further comprising purchasing equity shares in a company which becomes added to the subset of companies.

8. The system of claim 1, wherein the security is a note.

9. The system of claim 1, wherein the return is provided at the end of a fixed investment period.

10. The system of claim 1, wherein investment into the security is by way of purchase of shares in an account linked to the security.

11. The system of claim 1, further comprising providing an investment fund and using funds invested into the investment fund to invest into the security.

12. A method for investing in a managed list of equities, the method comprising:
issuing a security instrument;
using funds invested into said security instrument to purchase equity shares in a group of companies indicated in an investment analysis result, the investment analysis result being created by analysing information describing a plurality of companies according to a set of analysis rules and selecting a subset of said plurality of companies as said group of companies.

13. The method of claim 12, further comprising managing said purchased equity shares to reflect only those companies in said group at any given time.
